(19) United States
(12) Patent Application Publication
(10) Pub. No.: US 2007/0168485 A1
(43) Pub. Date: Jul. 19, 2007

(54) Computer system, method and software for establishing, managing, evaluating, classifying and storing on a server a set of server client digital media files under direct control of server client for delivery to third parties

(76) Inventor: Remi DuFour, Foster City, CA (US)

Correspondence Address: J G Mullins, Ste. 304, 1618 East Gate Way, Pleasanton, CA, 94566, US

(21) Appl. No.: 11/541,489

(22) Filed: Sep. 29, 2006

Related U.S. Application Data
(60) Provisional application No. 60/741,841, filed on Dec. 2, 2005.

(51) Int. Cl. G06F 15/173

(52) U.S. Cl. 709/223

(57) ABSTRACT

The present invention provides a network multi-theater forum and server management system, comprising a computer system loaded with at least one software module having logic that permits network server clients to individually collect, store, manage, and directly control computer digital media files in their theater area on the server management system and to offer, present and provide connections to such media files from their theater to third parties along with related information. The network multi-theater forum and server management system can include one or more programs, processes, software, and interfaces permitting network server clients to manage, control or access one or more individual theater features related to an individual theater name, content, access, advertising or statistics when such an individual theater is part of the network multi-theater forum.

### FIELD OF THE INVENTION

The field of the present invention relates generally to a network multi-theater forum and server management system, comprising a computer system loaded with at least one software module having logic that permits network server clients to individually collect, store, manage, and directly control computer digital media files in their theater area on the server management system and to offer, present and provide connections to such media files from their theater to third parties along with related information. In a preferred aspect, the network multi-theater forum and server management system includes one or more programs, processes, software, and interfaces permitting network server clients to manage, control or access one or more individual theater features related to an individual theater name, content, access, advertising or statistics when the theater is part of the network multi-theater forum.

### BACKGROUND OF THE INVENTION

Traditionally, digital and analog media consumers accessed public or private printed, audio or visual media to decide which recorded audio or visual media to purchase, to view, to listen, to go and see at the local movie theater, or to rent from a video or audio rental store to permit for home viewing or listening. In the past, those standard brick and mortar establishments provided the majority of recorded digital and analog media to consumers.

Recently, video and audio files have become more available over the internet and a rental copy of the media can be mailed to the end user along with postpaid return packaging, so the end user does not need to go to a local audio or video rental store that may or may not have the desired media selection. Websites that provide such media for rental are typically large, run by a single provider, and provide only the more popular selections to end users. With MP3 availability, end users can also download and pay for audio, video or combination media or games. Streaming media is more limited with respect to selections available and the quality of digital media files, and may be encrypted, or may be digitally or visually watermarked to prevent copying of the viewed or played media files.

More powerful computers and ready internet access (also know as the World Wide Web) have increased the popularity of digital multimedia transmission over the internet and receipt or use by computers attached to the internet. Servers attached to the internet can act as a large repository of audio files, photographs, games, still and movie style image files which can be down-loaded for viewing, storing and/or printing. For example, web pages that are available at servers hosting web sites on the internet often include digital image files that can be down-loaded by visitors to the web site or accessed by those visitors via streaming media.

There are several complications for digital file providers and end users, including cost of storage for digital media files on the server, cost of bandwidth for transmission of files to end users from the server and limitations on bandwidth and file format from the computer type and internet connection type of end users, as well as the cost per bandwidth and length of time for transmission to end users. Just setting up a website, providing the hardware and software, maintaining the site, advertising the site well enough for end users to locate it, and being able to bear the expense of all this can make it nearly impossible for anyone except for the larger and more established media file providers.

Accordingly, there is a need for a network multi-theater forum and server management system including software logic that will permit network server clients to individually collect, store, manage, and directly control computer digital media files in their theater area on the server management system. There is a need for such a system that will allow such network server clients to offer, present and provide connections to such media files from their theater to third parties along with related information without having to pay for or to manage a website infrastructure. There is a need for such as system that will permit network server clients to provide third parties access to their theater of audio, visual, games, photos, or other digital media without the need to have the know-how and without need to extend the finds to establish, advertise, manage, and run a large digital or analog media website.

### DEFINITIONS

The following non-exhaustive list of definitions is used herein to define terms that may otherwise be confusing or can sometimes have multiple meanings. Each occurrence of a defined term in the above text, in the text that follows, or in the claims of this document, is to be given the meaning ascribed to it in the list of definitions below.

“Bandwidth Reseller” as referred to in this document refers to a person who leases a transmission bandwidth from a provider and may lease all or a portion of that bandwidth to third parties for data transfer during the lease period.

“Data Transfer Limitations” as referred to in this document may refer to transmission time limitations, bandwidth limitations, total information transferred limitations, and may also be limited to occur within certain time periods.

“Fixed Period Bandwidth Lease” as referred to in this document means that a person leases a certain bandwidth for a certain set period of time (usually monthly), and has a set starting or ending date during which the bandwidth time may be used for data transfer by the person who leases the bandwidth from a provider.

“Floating Time Share Bandwidth” as referred to in this document means that a person can lease a certain bandwidth for a certain amount of time (such as 48 hours), but have a floating starting or ending date during which the bandwidth time (48 hours) may be used for data transfer.

“MBit(s) per hour” as referred to in this document defines the transmission speed of digital data over a transmission system. For example, 1 MBit per hour (bandwidth) for 750 hours would equal a total of 750 MBits transmitted. The greater the transmission speed (bandwidth) permitted or leased, the quicker data can be transferred from one location point along the transmission system to another system location point. MBit/s per hour can also be defined by other unit of times, such as per minute or per second without altering the definition.

“MBit(s) Transmission” refers to a total amount of digital information transmitted over an information transmission system. Either the rate limitation (transmission speed, or bandwidth) or the hours of transmission (or both) affect the total amount of digital information that is transferred. A person may be limited to a certain transfer rate (for example 1 MBit per hour) bandwidth in a 750 hour month would permit a maximum transfer of 750 MBits of total information that can be transferred during that month, but might actually be less, if less than the maximum bandwidth is used.

“Multimedia File” as referred to in this document is to be used in its broadest sense to include files with either visual content and audio content, or with both audio and visual content, and such files may be static (non-interactive, such as visual or audio type entertainment files) or dynamic (interactive, such as games, quizzes, puzzles, educational materials, and the like). The form of visual may include photos, presentation slides, flash, animations, movies, and other types of visual files. Multimedia visual files would also include live or recorded streams from web cams that are accessible through the forum, although they are neither static nor dynamic files as described above. Except in the claims, when any type of multimedia file is referred to (such as a “movie”), such is to be regarded as merely an example, and other types of multimedia.files are also envisioned. “Network Multi-Theater Forum” as referred to in this document is an Internet or intranet accessible forum wherein an actual or virtual website is parsed into two or more individually managed online theaters portions with their individually associated links, rather than a website offering multimedia files for rent or sale from a single vendor.

“network Server Client” as referred to in this document is not third party end users of the internet or intranet accessible forum, but is a theater manager who is a subscriber to the multi-theater forum in order to provide third parties end users access to at least one theater forum on the network multi-media forum.

“On-Line Theater” as referred to in this document means one or more sections of one or more pages, or one or more pages, of a website having multimedia files available publicly, or by private invitation, to third parties along with optional online store items for purchasing, wherein the format, selection, availability, and cost of theater multimedia files and optional store items for third party access or purchase are under the control of a theater manager who may permit accessing of multimedia files by third parties for playing of streaming video files or audio files, or optionally to permit downloadable multimedia files, and the like.

“Periodic Total Data Transfer Limitation” as referred to in this document means that a person is permitted to transfer up to a total data transfer amount (for example, 750 MBits) during a certain period of time, but may (or may not) be restricted to a bandwidth limitation for such transfers of data.

“Sharing” as referred to in this document with respect to control of content or revenue includes means either or both, direct and indirect managing of the control of content and revenue. In particular, sharing of revenue may be through indirect or direct means, such as through service fees or actual percentages or revenue obtained.

“Theater Manager” as referred to in this document is a server client (subscriber) who only leases or owns a portion of the main multi-theater website (partitioned multi-media website), over which portion of the website the theater manager is granted control under an agreement with the main multi-theater website (or virtual website) manager, or by a sub-manager who has more than one theater located on the main or virtual website.

### SUMMARY OF THE INVENTION

An object of the present invention is to provide a local or distributed computer digital media file repository and multi-theater server management system, comprising a user interface, a working memory storage area and at least one device for permanently storing information, wherein a portion of said memory of said system is loaded with at least one portion of a computer software program containing logic that permits network server clients to individually collect, store, manage, and directly control computer digital media files in their theater area on the server management system and to offer, present and provide connections to such media files from their theater to third parties along with related information.

In a preferred object of the invention, the network multi-theater forum and server management system includes one or more programs, processes, software, and interfaces permitting network server clients to manage, control or access one or more individual theater features related to an individual theater name, content, access, advertising, statistics or interactive features such as surveys and invitations when the theater is part of the network multi-theater forum.

One object of the present invention is to provide a local or distributed computer digital media file repository, network multi-theater forum and server management system, comprising a user interface, a working memory storage area and at least one device for permanently storing information, wherein a portion of said memory of said system is loaded with at least one portion of a computer software program containing logic that permits network server clients to individually collect, store, manage, and directly control computer digital media files in their theater area on the server management system and for network server clients to offer, present and provide connections to such media files from their theater to third parties along with related information.

In a preferred object of the invention such a network multi-theater forum and server management system further comprises one or more software programs, processes, and interfaces that permit network server clients to manage, control or access one or more individual theater features related to an individual theater name, content, access, advertising or statistics when the theater is part of the network multi-theater forum.

In a more preferred object, the present invention provides such a network multi-theater forum and server management system according further comprising software logic and an interface to permit network server clients to choose the payment terms and methods by which third parties can access the media files in an individual theater forum space, and optionally control over collection of such payments. In a preferred aspect, a network server client will have the exclusive right to any revenues collected from the theater forum that they manage, but may contract with the network multi-theater forum provider to directly or indirectly share revenues from shared advertising space, a common store, or the like.

Another object of the invention is to provide a network multi-theater forum and server management system, as described above, further comprising software logic and an interface to permit exclusive control for network server clients to post in their individual theater space of the network multi-theater forum information that is accessible to third parties selected from one or more of: pricing; media file information; media file previews or samples where the preview are in text, audio or video; viewer or listener reviews, ratings of media files popularity, viewing statistics for media files, categorized listings for media files located in a theater, and surveys, or feedback forms.

Preferably, the network multi-theater forum and server management system provides ordered and categorized (meaning ranking by all listed categories) statistics for media files access including number of views and viewers, generated revenues and appreciation marks that are listed according to when the theater first offered the media file, the total times access since first offered, yearly access, monthly access, weekly access, daily access, hourly access, or a combination thereof.

A further object of the invention is to provide such a network multi-theater forum and server management system as described above, further comprising software logic and an interface to permit exclusive control for network server clients to pay third parties fees or provide gifts and prizes to third parties in return for viewing or listening to a media file, creating or making a media file for uploading to the theater, or providing a review for a media file, or taking a survey (that may include questions related to a media file).

One preferred object is to provide such a network multi-theater forum and server management system, further comprising software logic and an interface to permit exclusive control for network server clients to select and invite third parties to access and enjoy a media file located in their theater forum, or in a different theater forum, wherein the listing and access to a media file may be visible or hidden from third parties other than such invitees.

Another preferred object of the invention is to provide such a network multi-theater forum and server management system as described above, further comprising software logic and an interface to permit exclusive control for network server clients to permit third parties to upload or otherwise provide a media file to the theater for other third parties to access, wherein the system provides network server clients with software logic and an interface to track revenue from such third party media files and compensate the third party for uploading or otherwise providing the media file to the theater.

A further preferred object of the invention is to provide a system wherein the network server client has software logic to optionally permit and manage the ability of third parties to submit media files to a theater and for the theater to make such media files available for accessing by other third parties without the person submitting the media file to the theater being required to first pay before placing a media files in the theater.

One object of the invention is to provide such a network multi-theater forum and server management system as described above, further comprising software logic and an interface to permit contests under the exclusive control of network server clients, or under the control of a forum manager, to pay third parties fees or provide gifts and prizes to third parties in return for the most popular viewing or listening for a media file during a set period of time on the theater or on the forum.

Another object of the invention is to provide such a network multi-theater forum and server management system, wherein the network server client has exclusive control over placement of any advertising media, or links to advertising, located in their theater area or located in media files available in their theater area, and the network server clients have the exclusive right to any revenue from such advertising or links, unless a contract with the network multi-theater forum provides for directly or indirectly shared revenue from certain theater forum activities. In a further preferred object, the invention provides such a network multi-theater forum and server management system, wherein the network server client has exclusive control over placement of any items for sale in an online store located in their theater area and to any revenue generated by such sales or from links to items for sale, except as otherwise provided by an agreement between the theater network server client and the network multi-theater website manager.

### DETAILED DESCRIPTION OF THE INVENTION

The present invention provides a local or distributed computer digital media file repository and multi-theater server management system, comprising a user interface, a working memory storage area and at least one device for permanently storing information, wherein a portion of said memory of said system is loaded with at least one portion of a computer software program containing logic that permits network server clients to individually collect, store, manage, and directly control computer digital media files in their theater area on the server management system and to offer, present and provide connections to such media files from their theater to third parties along with related information.

In a preferred embodiment, the network multi-theater forum and server management system includes one or more programs, processes, software, and interfaces permitting network server clients to manage, control or access one or more individual theater features related to an individual theater name, content, access, advertising, statistics or interactive features such as surveys and invitations when the theater is part of the network multi-theater forum. In a more preferred embodiment, the invention provides such a network multi-theater forum and server management system further comprising one or more software programs, processes, and interfaces that permit network server clients to manage, control or access one or more individual theater features related to an individual theater name, content, access, advertising or statistics when the theater is part of the network multi-theater forum

In another preferred embodiment the invention provides a rich and innovative set of tools for artists, newsmen, teachers, creative individuals in general and others wishing to express themselves by way of digital media. The tools (software logic and system) have been designed not only to let them create and control an environment to display their work inside a public forum but also to enhance innovation through the multiple interactive features present on the multi-theater forum according to the invention, such as multiple rankings, surveys, feedback, invitation, advertising and other sale opportunities. When properly utilized, this embodiment of the invention will permit such persons or groups of persons to take advantage of those tools to interact with those who share their passion, to discover new ideas and talent, to create innovative work and new source of wealth for themselves, and to keep the forum an unpredictable and fascinating place.

Because the network multi-theater forum according to the invention offers many options to its users, it is also well suited to respond to a broad variety of needs. This forum is therefore able to appeal to a large base of potential theater managers and their colleagues, which is advantageous for any type of forum that gains strength from the number of participants. The versatile design of the forum will permit the attraction of persons having disparate interests to the forum site where the diversity can keep enriching the palette of offerings available to their parties by the forum theaters and the overall forum site.

### OVERALL SYSTEM FOR ONE EMBODIMENT OF THE INVENTION

This description introduces, sometimes with a lengthy explanation, the main features of one embodiment of the system according to the invention and aims at connecting them in a way that shows their combination provides a unique service that has not previously been available to the public.

This embodiment of the invention provides a network multi-theater forum and server management system that permits the collection and playing of videos and music (multimedia) from/on the internet or intranet in an innovative way. Such collections are within multiple individually managed theaters of the forum, but collections of overall listings, ratings, or other statistics for the entire forum, or parts of the forum, may be included on forum pages accessible to the public and permit access to files on individually managed theaters.

The system according to the invention provides tools for any subscriber (network server client, or theater manager) to create and control a display environment on the multi-theater forum website. A useful analogy for the forum and associated system is that of a shopping mall where subscribers (theater managers) are retailers who select a retail space in the mall, pay fees to operate their store (rent, utilities) and control the nature of their business, the merchandise they sell, and their prices and other marketing strategies. Likewise, in one embodiment, the forum and server management system according to the invention gives subscribers control over a space in a larger environment managed by the forum itself (like mall owners who assume responsibility for facility maintenance).

In one preferred embodiment, the display environment for a theater is a web page (by use of the term “web page” it is meant both an individual web page or a section of a web page) created within the multi-theater forum specifically for a given subscriber and is identifiable to the forum, and possibly to third parties, as such. In one aspect, a subscriber can choose a transmission plan associated with a page or page portion to enable broadcasting, like a mall retailer would buy utility services to operate essential equipment for conducting its business. Subscribers may select one from several transmission options offered to them at the time of subscription.

In one embodiment, a subscriber can select from the transmission reseller, a flat Mbit(s) of transmission speed for a number of hours. For example, the forum or an agent of the forum could purchase a wholesale transmission plan and resell all or a portion of the transmission bandwidth of the plan. However, in a preferred embodiment, there is provided a floating time-share bandwidth plan. With such a plan, there is included the concept of a beginning and expiration date for an available bandwidth rate, where buyers would get the right to the transmission speed for a specified block of time, to be used between a start date/time and an end date/time of their choice. As in an option contract, the period of availability for a floating time-share bandwidth plan, can be shorter or longer and the cost may vary accordingly.

For an example of a floating time-share bandwidth plan, a subscriber could buy from a reseller (who has leased a higher or equal transmission speed at perhaps a monthly rate transmission speed) a bandwidth of perhaps 720 kbit/s for 96 hours of transmission between Nov. 10, 2005 4 am PST and Nov. 20, 2005 4 am PST. Obviously, the 96 hour period is shorter than the availability dates, and the buyer has a flexibility benefit.

One benefit of such a floating time-share bandwidth plan according to the invention is to give the buyer the possibility of choosing a usage time from among several available time frames, those time frames that are economically relevant to their needs and marketing efforts. An option to exercise a right can be more valuable with longer time of exercise. Thus, a subscriber who purchases four hours of transmission time to be used between today and tomorrow may get charged less than a subscriber who has the same right for an additional three weeks. A particular charge can depend upon subscription levels and a variety of other marketing factors. Depending upon web traffic conditions, the floating time-share bandwidth marketing procedure according to this invention can make it possible for a forum manager, or their agent, to offer the best price to subscribers and to enhance the quality of services provided.

In one embodiment of the invention, the control of a theater on the multi-theater forum according to the invention that page is enabled by a series of tools that the forum makes available to subscribers. Those tools include software to upload movies from a place designated by subscriber (storage on a computer or other electronic devices) to the webpage, or individual theater. Along with movies, subscribers can upload information related to the movie such as pictures, trailers, text. See below, regarding information related to the video. In a preferred aspect of the invention, subscribers can indicate preferences pertaining to the way a movie will be shown to the public. Such preferences can include pay-per-view, free and donation. See, compensation explanations below.

In a preferred embodiment of this invention, the display environment of a theater is made operational by software logic owned or operated by the forum. Of course, the site software will include logic that enable the showing of the movie at users' request by streaming audio and video, or by downloading. In addition to that primary function, such software logic in a more preferred embodiment will also track data related to the viewing, give usage reports to subscribers, and calculate and maintain their transmission account. With that maintenance, subscribers can keep track of usage and can make decisions to purchase additional transmission time with similar characteristics or not.

From the above paragraphs it is clear that the system according to the invention will permit subscribers to control the creation, content, and performance of their display environment (theater). Such control is automatically given to subscribers for them to be theater managers of their theater located within the multi-theater forum. The object of the control (entire and identifiable section—a theater), as well as the degree of control, provide novel and unexpected advantages for the present invention. See the discussion of the invention theater aspects, below, for additional details.

Conceptually, the forum allows any one with multimedia to come to the forum site and make their multimedia files available to third parties in the way they choose, in their own web-page or section of the forum just by subscribing to the forum. The forum also allows them to collect proceeds from the showing of their movies (see the discussion of compensation, below, for additional details), or from sales of articles connected to their movie, if any (see the discussion below regarding online sales.)

The forum will own, operate, or both own and operate software programs having logic that will allow registered third party users of a theater to view or listen to multimedia file located within available theaters according to the terms imposed by controlling subscribers.

The software programs of the forum contain logic that collects information on movies loaded on its servers and on viewing activities. It processes that information to provide statistics and uses those statistics to maintain rankings on movies (see the section below regarding rankings or rankings by sales). The forum may classify movies located within theaters of the forum according to several different categories, nested and not, by genres and by time of load up.

Such information processing by the forum can facilitate viewing choices for third party users of theaters located on the multi-theater forum and enhance their experience with the forum, in general. However, in this preferred embodiment, the forum is more than just a multimedia repository system that replicates the traditional movie watching experience at home or in theaters.

The forum provider will own, operate, or both own and operate software with logic that makes it possible for movie watchers (third party site users) and owners (or theater managers) to interact in a number of ways. The forum can provide the tools to develop an interactive community, which can foster increased artistic creation and profitability by giving movie owners more insights into what the interests of the viewing public are.

Rankings maintained by the multi-theater forum can indicate which movies are popular, their quality, and also their earning potential. That alone can be a tool for movie owners-makers and the viewing public to communicate implicitly.

In one aspect of the invention, the multi-theater forum manager can own, operate, or both own and operate software with logic that permits movie owners (or theater managers/subscribers) the option to propose that the viewing public fill-in a questionnaire designed by the movie owners (or theater manager), for compensation or for free. Movie owner (or theater managers as movie producers) will have therefore a tools at their disposal to collect feedback about their movies. See the discussion of survey services, below.

In a further aspect of the invention, the forum manager can own, operate, or both own and operate software with logic that permits movie owners, or theater managers, to invite groups of their choice to view movies. The selection of groups can be based upon a number of factors, such as viewing history, demographics, or both. See below the details for invitation services. Such a tool combined with a questionnaire (survey) tool can allows movie owners, or theater managers, to determine precisely what the taste of a specific group is just by using its forum account.

In some instances, a forum manager may own or operate software with logic that allows third party users of a theater on the forum to post a review for any movie they have watched. Lists of reviews can be sorted by many different criteria including movies and reviewers. Since part of the public may be attached on a specific person's opinion in order to select which movie to see, the sorting criteria makes it easy for them to see all reviews written by that person and select movies to watch accordingly. Conversely, a movie owner, or theater manager, can readily access all the reviews posted for one movie and learn from it.

When movie owners provide a movie for third party viewing, they may wish to permit third parties to contact them. A message system for the network multi-theater forum will allow any user to contact a movie owner who wishes to be contacted.

The above possible combinations of feature examples, when aligned with the innovative forum and purpose of a network multi-theater forum, can provide a novel way to develop a new, open community to any one with movies, from small to big, and to any person with an interest in movies, video, music and other multimedia file where such parties can interact and add value to the forum community.

Furthering the idea of a community where interest can be met is a feature offered to subscribers with movies that become part of the forum according to the invention. Subscribers are able to write a business proposition, explaining their purposes for their business, their competencies and any offerings/requests for services, and post such a proposition in a prominent place in the section they control. The public will be able to view their proposition as well as movies showcasing examples of their creativity and follow up if they desire by contacting movie owners by way of the forum messaging system. (See details below regarding internal services.)

In the same vein, movie creators can directly engage the public for ideas to develop/end the script of a movie by way of surveys. Both of these examples illustrate the high degree of possible interaction between movie makers and the viewing public that can be achieved with the forum and associated system.

As mentioned above, in one preferred embodiment, the forum and system can own, operate, or both own and operate one or more software programs having logic that permits a forum manager to classify and rank movies according to certain data and statistics. This, along with the interactive feature described above, make the forum experience rewarding from the movie watcher standpoint. It s also the case for those who own video and would like to distribute their video for sale, as the creation of a well-functioning open community enabling interaction is likely to increase demand for videos that are hard to access otherwise. In addition to increasing demand, the forum according to the invention provides tools to promote talent and enhance visibility, such as the visible and ubiquitous new movie section and charts, and a movie contest (see the video contest discussion below) that can reward high-ranking performers with prestige and prominence. Even for movies that are not on the top of the charts, the forum and its statistics can provide an unbiased, multi-dimensional reference for movie owners to point to when promoting their work.

In a more preferred embodiment of the invention, as described above, movie owners will be able to point to the forum and its statistics to illustrate the revenues generated by their movies, or the number of viewers, the quality indicators, or reviews. A good performance may generate recognition and enhance movies makers' career.

The forum according to the invention will also present movie owners with some tools that will enable them to generate revenues from viewers, from advertising, or from both. In addition to creating an interactive, where such a community environment can enhance or bring fame to movie owners, the forum can also provide tools to directly monetize those assets by collecting revenues.

In one of its more preferred aspects, the forum an system according to the invention will provide a unique mechanism to allow movie owners to automatically attach advertisements (videos) to their movie and to get compensated for it (see the details below regarding attached advertisements).

Unlike distributors who do not let video owners directly control part of their website that might interface with users, the forum according to the invention will provide such an option. Also, the forum according to the invention will permit a subscriber to reserve a space for that subscriber to control, instead of the move distributor controlling the whole space.

According to a preferred embodiment of the invention, a theater on a network multi-theater forum may be a web page within the main forum page on the forum website, or a portion of a page, where the theater is controlled by the designated subscriber(s). Preferably, that subscriber can lists videos with video information and other video-related items, from which listing each video can be launched and viewed by the public (provided the public registers first with the forum, with the theater, or with both). In a preferred aspect of the invention, controlled means that only the designated subscribers will have the ability to include videos in and remove video from the list of their theater. Of course, the forum can reserve the right to withdraw material from the list but only as recourse against abuses or users agreement violation. A subscriber may have the option to name the theater and refer to that name to designate their space.

A subscriber to the forum (theater manager) can also have the option to choose among different types of theaters to find the best match for their needs. Offered theater types can be: General (no restriction), Hidden (accessible with password and invitation only and not referenced in any part of the forum), and PPV only (this type of theater can impose the PPV type of compensation for all posted videos).

In a more preferred aspect, the present invention provides such a network multi-theater forum and server management system according further comprising software logic and an interface to permit network server clients to choose the payment terms and methods by which third parties can access the media files in an individual theater forum space, and optionally control over collection of such payments. In a further preferred aspect, a network server client will have the exclusive right to any revenues collected from the theater forum that they manage, but may contract with the network multi-theater forum provider to directly or indirectly share revenues from shared advertising space, a common store, or other similar joint undertakings. In one aspect, the invention provides such a network multi-theater forum and server management system, wherein the network server client has exclusive control over placement of any items for sale in an online store located in their theater area and to any revenue generated by such sales or from links to items for sale, except as otherwise provided by an agreement between the theater network server client and the network multi-theater website manager.

Another embodiment of the invention provides a network multi-theater forum and server management system, as described above, further comprising software logic and an interface to permit exclusive control for network server clients (subject to agreements, laws, and regulations) to post in their individual theater space of the network multi-theater forum information that is accessible to third parties selected from one or more of: pricing; media file information; media file previews or samples where the preview are in text, audio or video; viewer or listener reviews, ratings of media files popularity, viewing statistics for media files, categorized listings for media files located in a theater, and surveys, or feedback forms.

In a preferred aspect, the network multi-theater forum and server management system can provide statistics for multimedia files located in multiple theaters of the forum in an ordered and categorized (meaning ranking by all listed categories) set of statistics with respect to media files access including number of views and viewers, generated revenues and appreciation marks that are listed according to when the theater first offered the media file, the total times access since first offered, yearly access, monthly access, weekly access, daily access, hourly access, or a combination thereof.

A further embodiment of the invention provides such a network multi-theater forum and server management system as described above, further comprising software logic and an interface to permit exclusive control for network server clients to pay third parties fees or provide gifts and prizes to third parties in return for viewing or listening to a media file, creating or making a media file for uploading to the theater, or providing a review for a media file, or taking one or more surveys that may include questions related to a media file in a particular theater.

One preferred embodiment of the invention provides such a network multi-theater forum and server management system, further comprising software logic and an interface to permit exclusive control for network server clients to select and invite third parties to access and enjoy a media file located in their theater forum, or in a different theater forum, wherein the listing and access to a media file may be visible or hidden from third parties other than such invitees.

Another preferred embodiment of the invention provides such a network multi-theater forum and server management system as described above, further comprising software logic and an interface to permit exclusive control for network server clients to permit third parties to upload or otherwise provide a media file to the theater for other third parties to access, wherein the system provides network server clients with software logic and an interface to track revenue from such third party media files and compensate the third party for uploading or otherwise providing the media file to the theater.

A further preferred embodiment of the invention provides a system wherein the network server client has software logic to optionally permit and manage the ability of third parties to submit media files to a theater and for the theater to make such media files available for accessing by other third parties without the person submitting the media file to the theater being required to first pay before placing a media files in the theater.

Yet another embodiment of the invention provides such a network multi-theater forum and server management system as described above, further comprising software logic and an interface to permit contests under the exclusive control for network server clients to pay third parties fees or provide gifts and prizes to third parties in return for the most popular viewing or listening for a media file during a set period of time on the theater, or on the forum.

Another embodiment of the invention provides such a network multi-theater forum and server management system, wherein the network server client has exclusive control over placement of any advertising media, or links to advertising, located in their theater area or located in media files available in their theater area, and the network server clients have the exclusive right to any revenue from such advertising or links, unless a contract with the network multi-theater forum provides for shared revenue from certain theater forum activities. In a further preferred object, the invention provides such a network multi-theater forum and server management system, wherein the network server client has exclusive control over placement of any items for sale in an online store located in their theater area and to any revenue generated by such sales or from links to items for sale, except as otherwise provided by an agreement between the theater network server client and the network multi-theater website manager.

Below is a detailed description of a preferred embodiment according to the invention wherein the forum and system are called “GF” throughout the description. Below are some unique features of the GF embodiment of the invention.

1. Theater

Features of a theater within the GF forum are as described just above.

2. Compensation Per View

GF allows subscribers to show videos on the company's website and to choose the type of compensation they wish to receive/grant per viewing. GF is left out of the compensation type decision. It's entirely the subscribers' decision.

3. Types of Compensation

GF offers a unique combination of compensation per view options:
Pay-per-view: whereby viewers have to pay a fee to view the video in its entirety, or to pay a fraction of the fee if a video is not entirely viewed
Donation: whereby viewers make a donation of their choice after watching the video
Free: whereby viewers do not have to pay to watch the video
Compensated: viewers will receive compensation after watching the video.
   4. Amount of Compensation

GF allows subscribers to show videos on the company's website and to choose the amount of compensation they wish to receive/grant per viewing from 0 to an unlimited amount. GF is left out of the compensation amount decision. It's entirely the subscribers' decision.

5. Information Related to A Video

GF allows subscribers to post directly (meaning they perform the complete operation themselves and there is no immediate control from GF) to the GF site (in their theater) information related to videos including title, technical information, rating for content, information on participants such as actors, directors and other parties involved in the making of the video, pictures and trailers.

6. Survey Services

Without the intermediary of GF personnel, GF enables subscribers to propose their videos' viewers to take a survey after watching the video for a compensation amount of subscribers' selection. For example, during the movie upload process, subscribers can be asked if they want to add a survey that viewers will be able to take after they view the video. If they select the Yes option, a program can open a form that the subscriber can fill with the questions they wish to ask the viewers. Subscriber can indicate the compensation amount to be given to the survey taker. After watching the corresponding movie, viewers are asked if they want to take survey for the compensation amount. If yes, the form with the question is presented to them. The form is able to collect the viewers' answers to these questions and a program creates corresponding records after submission. There is a program that collects those records and makes them available to the subscriber that has ordered the survey.

7. Invitation Services

GF can run a software program with logic that enables subscribers with videos to send invitation to individuals selected based on characteristics including demographics and viewing history. The GF forum includes a software program with logic that allows subscribers with videos to send invitations to see a movie posted in one of their theaters. The program can let a subscriber specify the movie, the theater and a password to access the theater if necessary. Then the program can then let subscribers specify one or more characteristics for the group that they wish to invite based on viewing history (subscribers specify which movie(s) played on the site invitees should have watched) and/or demographics (characteristics indicated by users in their profiles such as gender, age, schooling . . . ). When that information is submitted, a forum software program can select matching applicants from its database(s), or subscriber databases, and send them an email with the invitation information.

8. On-Line Sales Services

The GF forum can provide software logic and an interface enabling subscribers to list items related to any video showing, receive a sales order for any of those listed items and get paid through GF. For example, during the movie upload process, subscribers are asked if they want to add an online sales form to sell items related to the video. If they select the Yes option, a program opens a form that the subscriber can fill to describe the merchandise(s) they want to sell and conditions of sales. There is a program that establishes a link between the form and the section where the video is shown on the subscriber theater. The link indicates there is merchandise for sale and when users click the link they are directed to the form that describe the merchandise for sales and also collects information necessary to make sale such as quantity, size etc . . . , and calculates sales amount. After submission, a program creates corresponding records and sends a copy of the order to the seller. A program collects the payment from the buyer and passes it on to the sellers account, but the seller is sole responsible for fulfillment of the order.

9. No Money Down Broadcasting Services

Without the need for an intermediary of GF personnel, GF can allow subscribers to show video on the company's website without making any upfront payment.

10. Marketing Of Goods And Services

Without the need for an intermediary of GF personnel, GF can allow subscribers with videos to propose or request services involving videos, select and contract services/goods (such as the DVD version of the video), and pay for these services all within GF website. For example, GF will let subscribers include a business proposition in their theater. Visitors interested may contact the owner by email through the internal message system. Service purchaser may select service provider by examining their work posted on GF. Contract can be exchanged by email. Payment can be made using GF internal compensation system.

Services Example: An advertising firm is NY is a subscriber and shows its work on GF. Its theater proposition includes: “We are looking for new advertising videos for products/services shown in this theater from ad agencies located in a more cost effective location or country. Please send us your theater name so we can look at your current work”. That theater features videos listed in the Advertising section and can be found by subscribers interested in Advertising. Otherwise the firm can send invites. Several firms with a theater can answer the call. After review of their posted videos the selection is made. The selected firm is asked by email to produce a specific ad video for $300. The selected firm produces the video, opens a private theater, and show the video with the donation option. Then they contact the client, invite and give the password for the private theater, and ask the client to make a $300 donation if they wish to acquire the video. If the client does, the firm can then send them the DVD after getting paid. If not, the client can decline to make a donation and cannot see the video anymore.

11. Rankings by Sales

The GF provides one or more software programs with logic that provides ranking of videos and theaters (separately) by gross receipts (proceeds from PPV, donations, or advertising) for different period of time including but not limited to: last hour, last day (past 24 hr), last week (past seven days), last month (past 30 days), since posting (for videos), since creation (for theater). Those ranking are updated periodically (may be real time) and show the earning power of any video or group of videos. For example, each time a viewer plays a movie that generates some revenue for the owner a program on GF records that transaction. For each movie of that type a program calculates the total revenue generated. A program compares revenues accumulated in specific time windows and established for each time window a ranking of revenues and associated movies.

12. Rankings

The GF forum provides rankings of multimedia files and theaters (separately) by gross receipts (proceeds from PPV or donation), quality indicators collected from the viewing public, and number of viewers for different period of time including but not limited to: last hour, last day (past 24 hr), last week (past seven days), last hour, last month (past 30 days), since posting (for multimedia files), since creation (for theater). Those ranking are updated periodically (may be real time) and collectively show the earning power, quality and popularity of any multimedia file or group of multimedia file thereby offering the most complete performance profile of any multimedia file broadcasted or downloaded on the web.

For example, each time a viewer plays a movie, a program records that transaction. If the viewer opt to give a rating to the movie after watching it (a program launched after the movie has been watched allows the viewers to give a quality mark to the movie and such a mark is recorded for that movie), a program records that transaction. For each movie a program calculates the total number of viewers and the total number of quality marks. A program compares numbers of viewers and quality marks accumulated in specific time windows and establishes for each time window a ranking for each indicator and associated movies.

13. Multimedia file Contest Based On Revenues

GF rewards multimedia file with the highest monthly gross receipts with a prize and give privileged exposure to winning multimedia file on its website. All videos posted on GF are automatically enrolled in the contest. For example, each month, GF runs a program that identifies the movie with the highest monthly gross receipts (using the existing ranking systems) and credits the account of the owner with the prize amount. A program includes the title and link of the winner in a list of winners figuring on GF's home page.

14. Attached Advertisement

The GF forum provides one or more software programs with logic that provides subscribers with multimedia file (such as a new movie) to bid for the right to attach their file to a multimedia file (such as a popular movie) of their choice of any multimedia file that is willing to receive an attachment for pay. Bidders, likely advertisers, are able to show their chosen movie before or after viewers watch the movie they want to view. To acquire this privilege, bidders agree to pay a certain amount each time their attached movie is watched. For example, at the upload any movie owner can signal there are willing to play advertising movies before, during or after their videos. A question on the upload form simply asks if the movie is a candidate for attached advertisement.

In one embodiment, a GF software program contains logic that lists all the multimedia candidates (e.g., movies) available for attachment. Advertisers interested in showing their advertisement video may come to that list and select movies they want their video to be attached. Advertisers also list the price they are willing to pay per view and other parameters. A program records their bid information and matches all candidate movies with an advertising video, most likely the one offering the highest compensation per view. The GF forum includes a software program logic that attaches the paired videos so that they play together when a viewer decides to watch the candidate movie. GF can also include a software program with logic that debits the advertisers account each time this video is shown by a specific amount and credits the account of the owner for the candidate video.

The following non-limiting examples are provided to better illustrate the invention. Other applications for the elements of this invention will be apparent to people who ordinarily work with multi-media file storage and their transmission.

### EXAMPLES

### Example 1

Exposure and Reward for Quality Material

An unknown user may have very attractive material and post it in a theater on the network multi-theater forum as described above. Because of the popularity of the network multi-theater forum, posting in a theater on the forum gives prime exposure to the new material, as it is displayed on the home page of a theater and may also be posted in a main theme page of the network multi-theater forum during its first week of posting. Multiple posting creates further exposure, by posting a link to a new multimedia file in a specific category list on main forum pages regarding similar media files available in one or more theaters within the network multi-theater forum, and optionally in a category listing for a particular theater within the network multi-theater forum. This will permit users who browse for new material or for material related to a specific interest to get exposure to the new material.

If very attractive new material is noted thus by the network multi-theater forum main ratings and reviews pages, material can get further exposure. If material gets very high quality marks and reviews, by being posted on the forum reviews and ranking pages, then more traffic accessing the new material can lead to even higher ratings and reviews. These very high quality marks and reviews will continue to add further to the material's attraction and will bring even more quality marks and reviews, therefore reinforcing the visibility of the material.

Success for new material may be limited to the material's specific category, or may go beyond that category. When material shows exceptional performance, performance may also be displayed in rankings for any of the groups where the category belongs, up to the general rankings displayed on the forum home page. There is no limit to the success it can have. As the number of viewers grows, increasing solicitations for advertisement placement on the material may translate into higher monetary offers and, thanks to a forum advertising system, higher advertising revenues for the material.

Price per viewing may also be revised as seen fit by the material owner to increase revenues. The owner of the material can point later to material's performance on the forum as a reference. As the owner doesn't control rankings, revenues and other marks, and is in competition with many other posted materials, performance on the network multi-theater forum will be objective and significant.

### Example 2

Individual Theater Managers

Network server clients who wish to have their own on-line theater space, under their own control, can do so without the need to understand and manage a website. They also can avoid a great deal of other start-up costs. For example, they need not spend money trying to develop initial internet traffic to their site, since the network multi-theater forum will itself provide a certain amount of traffic to any theater located on the site. They need only upload their multi-media files and design the look and feel for their individual theater.

As individual theaters for network server clients become more recognized, they will add to the popularity of the network multi-theater forum. Other theaters will also attract traffic and the diversity of theaters can provide “one stop” shopping for third parties who like a variety of multi-media files that may not be available anywhere else.

### Example 3

Market Research for Value Analysis and Pricing

Movie makers can use a theater on the network multi-theater forum to run pilots at very low cost, rapidly and more precisely that before. They can use forum tools to invite users based on the profiles they specify and have them take compensated surveys, as many as they wish. As a result, movie makers can understand the tastes of targeted segments easily, rapidly and at low cost, and therefore avoid producing big-budget movies that the public won't like. As the forum can permit both private and hidden theaters (in addition to the visible theaters), movie makers can have the choice to remain anonymous while experimenting. This is an advantage that they don't get if they use their in-house or traditional online venues.

In addition to researching public taste with surveys, movie-makers may also study the forum's rankings to find which features seem popular, and the relationship between that popularity and revenues. They can use their findings to include a greater number of desirable features in their movies and thereby increase their chances of enhancing movies' profitability.

### Example 4

Entrepreneurial Opportunities

Theater managers (network server clients) can propose services using their own controlled space. For example, managers living in areas of interest to others can propose recording local video scenes for a fee and posting them on the site for a fee to provide a virtual video vacation, or video or audio recordable information of interest (such as regional or technical information, mapping, architectural data, local features, or other information) for any designated place of interest. This is easily made possible because there is a message system within the forum that will allow contact between third parties and theater managers, and also because services can be readily compensated for with the pricing option that theater managers have.

Potential clients for service providers can also form an opinion about the quality of the service providers proposed work by watching videos that are already posted by a service provider. That type of service might be popular with the tourism industry, historians, architects, and naturalists.

The software aspects of the invention can also be embodied as computer readable code on a computer readable media. The computer readable media is any data storage device that can store data which can be thereafter be read by a computer system. Examples of the computer readably media include read-only memory, random-access memory, CD-ROMs, magnetic tape, optical data storage devices. The computer readable media can also be distributed over a network coupled computer systems so that the computer readable code is stored in a distributed fashion.

The present invention may be embodied in specific forms other than those particularly described above or illustrated by the above examples. Upon viewing the present application preferred embodiments and other descriptions herein of the present invention, variations and other implementations that do not depart from the spirit and scope of the present invention will be apparent to one of routine skill in this field. Such variations and other implementations are considered part of the present invention and within the scope of the appended claims. Accordingly, reference should be made to the appended claims, rather than to the forgoing specification and examples, as indicating the scope of the present invention.

I claim:

1. A local or distributed computer digital media file repository, network multi-theater forum and server management system, comprising a user interface, a working memory storage area and at least one device for permanently storing information, wherein a portion of said memory of said system is loaded with at least one portion of a computer software program containing logic that permits network server clients to individually collect, store, manage, and directly control computer digital media files in their theater area on the server management system and for network server clients to offer, present and provide connections to such media files from their theater to third parties along with related information.

2. A network multi-theater forum and server management system according to claim 1, further comprising one or more software programs, processes, and interfaces that permit network server clients to manage, control or access one or more individual theater features related to an individual theater name, content, access, advertising, statistics, surveys, and invitations when an individual theater is part of the network multi-theater forum.

3. A network multi-theater forum and server management system according to claim 2, further comprising software logic and an interface to permit network server clients to choose the payment terms and methods by which third parties can access the media files in an individual theater forum location, and may optionally further comprise software with logic for the forum itself to manage one or more of billing, collecting, allocating, or dispersing of funds from third parties who directly or indirectly access an individual theater forum space to watch, listen, use, or play multi-media files or to post at least one advertisement within the individual forum space.

4. A network multi-theater forum and server management system according to claim 2, further comprising software logic and an interface to permit the forum itself or an associated forum provider to provide, manage, or provide and manage, network server client accounts with periodic total data transfer limitations, periodic fixed bandwidth limitations, or floating time share bandwidth limitations.

5. A network multi-theater forum and server management system according to claim 2, further comprising software logic and an interface to permit exclusive control, or control shared with the forum, for network server clients to post in or on their individual theater space, where the theater space may include one or more web pages, links or information that are accessible to third parties items selected from one or more of: pricing; media file information; media file previews or samples where the preview are in text, audio or video; viewer or listener reviews, ratings of media files popularity, viewing statistics for media files, categorized listings for media files in the theater, content listings, and survey feedback forms.

6. A network multi-theater forum and server management system according to claim 2, further comprising software logic and an interface to permit a network server client to share revenue or control over one or more of advertising spaces, links, or theater files with another network server client or with a network multi-theater forum provider.

7. A network multi-theater forum according to claim 2, wherein the software and logic permits posting in an individual theater, on forum pages, or both, statistics for multimedia files that includes one or more statistics related to the number of times a file is accessed, since first offered, yearly access, monthly access, weekly access, daily access, or hourly access.

8. A network multi-theater forum and server management system according to claim 7, wherein the software and logic provides one or more listing of statistics for media files accessed in individual theaters, in groups of theaters, or in all the theaters of the forum, and media file statistics are listed according to when the theater first offered the media file, the total times access since first offered, yearly access, monthly access, weekly access, daily access, hourly access, or a combination thereof.

9. A network multi-theater forum according to claim 8, wherein the forum provides one or more forum statistics pages having ordered and categorized statistics with rankings within all listed categories, overall rankings, or both.

10. A network multi-theater forum according to claim 9, wherein the statistics for multimedia files include one or more sets of statistics related to one or more of the number of views and viewers, generated revenues, and viewer or expert appreciation ratings for media files in a single theater, in a group of theaters, or in all the theaters.

11. A network multi-theater forum according to claim 10, wherein the statistics for multimedia files includes the number of views and viewers, generated revenues, and viewer or expert appreciation ratings.

12. A network multi-theater forum according to claim 2, wherein forum statistics are provided that rate for third parties all of the theaters on the forum, or a group of theaters, according to their popularity, which popularity may be measured by one or more factors selected from number of multimedia files, revenue, viewings, viewers, and appreciations ratings by viewers or experts.

13. A network multi-theater forum and server management system according to claim 2, further comprising software logic and an interface to permit exclusive control for network server clients to pay third parties fees or provide gifts and prizes to third parties in return for viewing or listening to a media file, creating or making a media file for uploading to the theater, or providing a review for a media file.

14. A network multi-theater forum and server management system according to claim 2, further comprising software logic and an interface to permit exclusive control, or shared control, for network server clients to select, to invite, or both select and invite, third parties to access and enjoy a media file located in their theater forum, or in a different theater forum, wherein the listing and access to a media file of a theater may be visible or hidden from third parties other than such invitees.

15. A network multi-theater forum and server management system according to claim 2, further comprising software logic and an interface to permit exclusive control for network server clients to permit third parties to upload or otherwise provide a media file to the theater for other third parties to access, wherein the system provides network server clients with software logic and an interface to track revenue from such third party media files and compensate the third party for uploading or otherwise providing the media file to the theater.

16. A network multi-theater forum and server management system according to claim 2, further comprising software logic and an interface to permit contests under the exclusive control of network server clients, or a forum manager, to pay third parties fees or provide gifts and prizes to third parties in return for the most popular viewing, using, playing, or listening of a media file, or a group of media files, during a set period of time on the theater, or on the forum.

17. A network multi-theater forum and server management system according to claim 14, wherein popular viewing or listening, may be one or more of highest revenues, highest quality ratings, or highest number of view or viewers.

18. A network multi-theater forum and server management system according to claim 2, wherein the network server client has exclusive or shared control over placement of any advertising media, or links to advertising, located in their theater area or located in media files available in their theater area, and the network server clients have the exclusive or shared right to any revenue from such advertising or links.

19. A network multi-theater forum and server management system according to claim 2, wherein the network server client has exclusive or shared control over placement of any items for sale in an online store located in, or accessible from, their theater area and to any revenue generated by such sales or from links to items for sale.

20. A network multi-theater forum and server management system according to claim 15, wherein the network server client has software logic to permit and manage the ability for a third party or a network server client to provide media files to the theater, or to the forum, for the theater or forum to make them available for access by other third parties without first paying for placement of the media files in the theater or forum.
